(19) United States
(12) Patent Application Publication
(10) Pub. No.: US 2014/0182198 A1
(43) Pub. Date: Jul. 3, 2014

(54) Water Retention Agent and Preservation Method

(71) Applicant: Blue Norther Investments, LLC, Heath, TX (US)

(72) Inventors: Kazuyuki Koyama, Saitama (JP); Junko Yamada, Saitama (JP); Shunsuke Ikuno, Saitama (JP)

(73) Assignee: BLUE NORTHER INVESTMENTS, LLC, Heath, TX (US)

(21) Appl. No.: 14/142,423

(22) Filed: Dec. 27, 2013

(30) Foreign Application Priority Data
Dec. 28, 2012 (JP) 127829PS
Dec. 24, 2013 (JP) PCT/JP2013/084495

(51) Int. Cl. A01G 9/02; B01J 20/24

(52) U.S. Cl. CPC A01G 9/02; B01J 20/24
USPC 47/41.01; 47/58.1 CF; 252/194

(57) ABSTRACT

A fiber aggregate having cellulose fibers as a principal component. The cellulose fibers have an average fiber diameter of about 25 microns or less, and may be clustered together. Per gram of fiber aggregate, the cellulose fibers may hold about 10-21 mL of an impregnating solution that has water as a principal component. The fiber aggregate may be included as part of a water retention agent for flowers and/or woody ornamental plants.

### CROSS-REFERENCE TO RELATED APPLICATIONS

This application claims the benefit of and priority to Japanese Patent Application No. JP127829PS, entitled “Cut Flower Preservative and Preservation Method,” filed Dec. 28, 2012, the entire disclosure of which is hereby incorporated herein by reference.

This application also claims the benefit of and priority to PCT Application No. PCT/JP2013/084495, entitled “Cut Flower Water Retention Agent and Preservation Method,” filed Dec. 24, 2013, the entire disclosure of which is hereby incorporated herein by reference.

### BACKGROUND OF THE DISCLOSURE

Over the past decade the market for flowers and ornamental plants has changed. Supermarkets, wholesale clubs, and internet/e-commerce delivery services have become increasingly important sales channels for fresh cut flowers. The traditional time from farm to consumer may be as long as fifteen days, although this may be streamlined somewhat by grower-direct sales to retail florists and supermarkets. Internet e-commerce sites for floral products have gained in popularity, representing yet another change in the way flowers are distributed and sold to consumers. In the case of home delivery, additional time may be required to reach the consumer for various reasons, e.g., because they are not at home. Regardless of the method of distribution, fresh cut flowers are a perishable commodity. Therefore, they need to be handled in such a way as to maintain appearance, quality, and freshness throughout the distribution channel from the grower to consumer. By maintaining freshness and quality during transportation, storage, and handling, it is possible to extend the vase life of cut flowers. The production of fresh cut flowers has seen an increase in several areas, such as Malaysia, Thailand, and Africa, which have not been traditionally among the leaders in flower exports. In many of these areas, transportation infrastructure is under-developed, which may increase the time-to-market of harvested flowers. Consequently, an efficient, easy-to-use method of supplying water and nutrients to flowers is essential to maintain appearance and freshness. Various transportation methods are used to move fresh cut flowers from the producer to the consumer. A common practice used to ship flowers is the cold-chain method, whereby flowers are packed in shipping boxes and chilled, and a controlled temperature is maintained during transit and storage. Another common practice is to ship flowers in a wet system, where flowers are exposed to a source of water, usually in a vase or other container suitable for liquids. Conversely, flowers may also be shipped in a dry system where no water is supplied during transit.

Generally, shipping flowers using the wet system, whereby water is supplied during shipment to the consumer, is considered a superior way to preserve freshness and appearance. However, the disadvantages of using water during transportation include the possibility of leakage or spillage, whereby flowers must be shipped and handled in a vertical position so as not to spill water from the vase or container. Another disadvantage is that the use of water during transit requires additional labor to fill vases or containers, and these may need to be monitored and refilled periodically, depending on the type of flower, the size of the vase, and the amount of water initially used. Methods that use a water-absorbent material to supply water have also been developed to solve the aforementioned spillage problem. Various water retention materials such as pulp or other water-absorbent fibers have been proposed. Water-retaining gels made of superabsorbent polymers, some of which use toxic acrylamide as the monomer base material, are also used. Yet another material, a water-absorbent sheet which is used to wrap the stems of plants. However, none are adequate to maintain freshness or quality of flowers for an extended period of time. Additionally, when another water-absorbent material such as cotton is used, the lower ends of the flower or ornamental plant stems must be wrapped with the absorbent, water-supplying material and subsequently sealed in a waterproof bag, requiring additional labor.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts the appearance, over time, of cut roses utilizing water, prior art water retention agents, and a water retention agent according to one or more aspects of the present disclosure.

FIG. 2 depicts scanned electron microscope (SEM) photographs of cellulose fibers of the prior art and according to one or more aspects of the present disclosure.

FIG. 3 is a graph depicting weight loss of cut roses when utilizing water, prior art water retention agents, and a water retention agent according to one or more aspects of the present disclosure.

FIG. 4A includes photos depicting the appearance, over time, of cut Turkish Bellflower plants utilizing water and a water retention agent according to one or more aspects of the present disclosure, as well as a graph charting their weight with respect to time.

FIG. 4B includes photos depicting the appearance, over time, of cut Margaret Aster plants utilizing water and a water retention agent according to one or more aspects of the present disclosure, as well as a graph charting their weight with respect to time.

FIG. 5 includes photos depicting the appearance, over time, of cut Peach Blossom plants utilizing water and a water retention agent according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

One or more aspects of the present disclosure may pertain to a water retention agent and/or method that may aid in maintaining satisfactory appearance, quality, and/or freshness of cut flowers, perhaps for an extended period of time.

One or more aspects of the present disclosure may pertain to a water retention agent and/or method that may aid in maintaining satisfactory appearance, quality, and/or freshness of flowers and/or ornamental plants, and/or that may not require the addition of water during the distribution process, and/or which may avoid or reduce concerns over water spillage or leakage, and/or which may avoid or reduce labor otherwise needed to replenish water in vases and/or shipping containers.

One or more aspects of the present disclosure may pertain to a water retention agent and/or method that does not utilize specialized equipment and/or labor, and/or that may be easy to handle, and/or that flowers and/or ornamental plants utilizing the water retention agent and/or method may easily be shipped, handled, and/or distributed.

One or more aspects of the present disclosure may pertain to a water retention agent and/or method pertaining to flowers and/or ornamental plants that may utilize a fiber aggregate that may have cellulose fiber as the principal component, and/or that may be characterized in that the fibers may have an average diameter of about 25 microns or less, and/or that such fibers may agglomerate and/or form clusters, and/or that such fibers may hold a predetermined amount of an impregnating solution per gram of fiber aggregate, wherein the predetermined amount may range between about five mL and about fifty mL, such as between about ten mL and about 21 mL, and wherein the impregnating solution may have water as the principal component.

In implementations within the scope of the present disclosure that utilize fibers having an average fiber diameter of about 25 microns or less, wherein flowers and/or ornamental plants are inserted into the resulting fiber aggregate, the cut ends of the stems thereof may be encased and/or covered by the fibers. Peripheral fibers may also sufficiently hold water due, for example, to capillary action, such that the flowers and/or ornamental plants may be adequately supplied with water.

In implementations within the scope of the present disclosure that utilize the predetermined amount of the impregnating solution per gram of fiber aggregate, the fiber aggregate may hold sufficient water due to capillary action, for example, such that substantially no free liquid separates from the cellulose fibers, which may avoid or reduce spillage and/or leakage. Moreover, where such implementations utilize fibers having an average fiber diameter of about 25 microns or less, sufficient moisture may still be released and thus be available for absorption and/or uptake by stems of the flowers and/or ornamental plants.

One or more aspects of the present disclosure may pertain to a water retention agent and/or method pertaining to flowers and/or ornamental plants that may be characterized in that the aforementioned fiber aggregate may utilize wood pulp as a starting base material. In such implementations, it may be possible to reliably obtain a cellulose fiber base material with the above-described average fiber diameter, and/or the risk of harmful substances being produced when the cellulose fiber is disposed of as waste and/or incinerated may be reduced or eliminated.

The present disclosure introduces a fiber aggregate that has cellulose fiber as the principal component, that may be characterized by fibers with an average diameter of about 25 microns or less, that may form agglomerates or clusters, and that about one gram of the fiber aggregate may hold about 10-21 mL of an impregnating solution that has water as the principal component. With a cellulose fiber aggregate that satisfies one or more of these conditions, moisture may be sufficiently held and adequately released for absorption, and the fine diameter of the cellulose fibers may permit the cut ends of flowers and/or ornamental plants to be encased. Moreover, due to the fine fiber diameter and short length of the fibers, the fiber aggregate of the present disclosure may be easily dispensed into bags or other containers by package filling equipment.

The present disclosure also introduces a flower and/or ornamental plant water retention method characterized in that, for example, the stems of cut flowers and/or ornamental plants may be inserted in the aforementioned water retention agent so as to encase the cut ends of the stems. With the water retention method(s) of the present disclosure, the appearance and freshness of flowers and/or ornamental plants may be extended for a longer period compared to conventional water retention materials. Therefore, they may survive the transportation and/or distribution processes in better condition, perhaps reaching the consumer in satisfactory condition and with extended vase life.

The flower and/or ornamental plant water retention method of the present disclosure is also characterized in that the aforementioned flower and ornamental plant water retention agent may be utilized in a leak-resistant container, the stems of cut flowers may be inserted therein, and the opening of the container may be sealed around the stems. By putting the flower and/or ornamental plant water retention agent of the present disclosure into a waterproof bag or other container, inserting cut flower stems, and sealing the opening of the container, it may be possible to arrange and sell as-is at a florist, supermarket, or other store. Therefore, in addition to maintaining flower appearance and quality, one or more aspects of the present disclosure may be easily integrated into various types of point-of-sale floral displays utilized by florists and merchants.

One or more aspects of the present disclosure may be utilized to maintain appearance, quality, and freshness of cut flowers using fiber aggregates with cellulose fiber as the principal component. The ability to preserve freshness may vary according to the composition of the fiber aggregate. The following explains an embodiment of the present disclosure in further detail based on evaluation data.

It was studied whether flower appearance and freshness were influenced by the amount of water or nutrients added per gram of cellulose fiber aggregate. When about 22 mL of water are added to about one gram of cellulose fiber aggregate, the saturation point of the cellulose fibers may be exceeded, such that the cellulose fibers cannot completely absorb all of the liquid. The result is free liquid, which can leak or spill. Therefore, the upper limit of the amount of water or nutrients added per gram of cellulose fiber aggregate may be considered to be about 21 mL. At this point of optimal saturation, the water retention agent may be placed in a waterproof bag or container, cut flower or plant stems may be inserted, and the opening may be sealed around the stems without leakage or spillage of liquid. Since the risk of leakage may thus be reduced, if not avoided, flowers can be packed and transported horizontally in cardboard boxes or other types of shipping containers. Shipping configurations may then be arranged in such a way as to maximize the amount of flowers that can be packed into a box or container, which may reduce shipping costs while maintaining the quality and appearance of the flowers.

The lower limit of water per gram of cellulose fiber aggregate may vary according to the transport and delivery time for the flowers to reach the consumer, and/or by the amount of water absorbed by the flowers. The amount of water absorbed, per day, may depend on various factors, such as the type of flower, the size of the plants, air temperature, and humidity. For example, a rose spray of average height may absorb about 10-20 mL of water per day. In addition, reducing the amount of water per gram of cellulose fiber aggregate may reduce and/or minimize weight and shipping costs for short-term deliveries (among others). Evaluation trials have indicated that a minimum limit of about ten mL of water per gram of cellulose fiber aggregate may maintain freshness and appearance for several days, regardless of temperature, humidity, transportation time, or flower species. Therefore, it may be possible to reach the consumer while maintaining satisfactory quality and freshness.

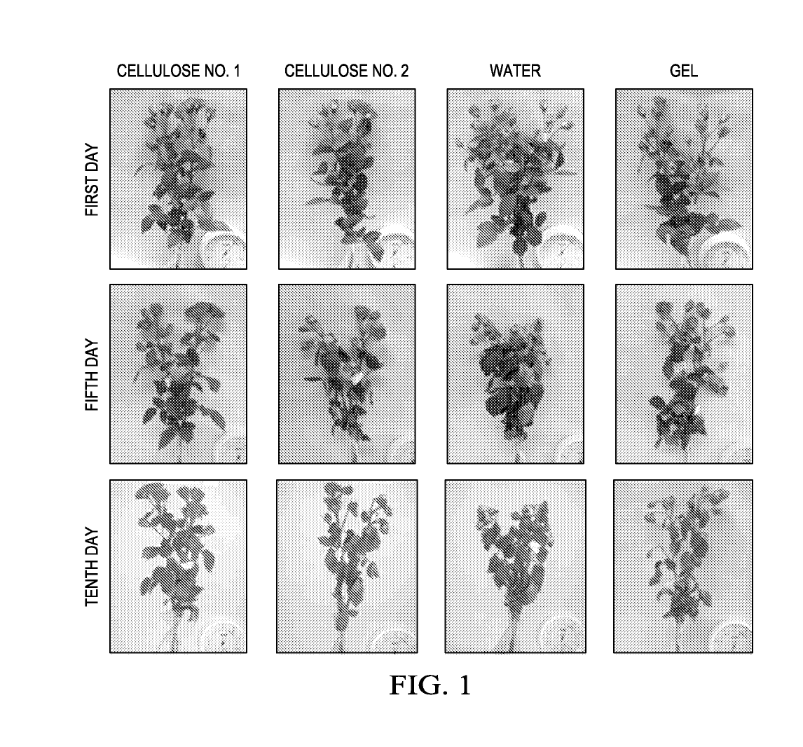

Accordingly, the desired range of impregnating solution with water as the principal component may be about 10-21 mL per gram of fiber aggregate. Next, various types of fiber aggregates, with cellulose fiber as the principal component, were evaluated as a water retention agent for cut flowers. The degree of quality, freshness, and appearance of cut flowers was evaluated utilizing fiber aggregates with different sizes of cellulose fiber as the principal component. Water and a water-retaining gel normally used to hydrate cut flowers were utilized as standards of comparison (i.e., as controls). Examples of the results are shown in FIG. 1.

For the fiber aggregate with cellulose fiber as the principal component, two formulations were prepared from split wood pulp with different fiber diameters and fiber length, herein referred to as Cellulose No. 1 and Cellulose No. 2. Each formulation also included sugar, magnesium nitrate or another salt, and a preservative. Additional treatments included plain water, and a commercially available water-retaining gel that is commonly used with cut flowers. Each preparation was put into its respective vinyl bag, the cut flower stems were inserted, and the opening was closed to retard moisture evaporation. During the observation period, the condition of the flowers in each treatment was recorded daily. The average air temperature during the test period was about 20° C., and the average relative humidity was about 60%.

FIG. 1 clearly shows that, on the fifth day of the study, when Cellulose No. 1 was used as the water retention agent, there was no wilting. In contrast, where Cellulose No. 2 and the water-retaining gel were used as the water retention agent, wilting was evident. Where plain water was used, both the flowers and the leaves exhibited wilting.

On the tenth day of the study, where Cellulose No. 1 was used, the flowers still maintained a satisfactory level of freshness, appearance, and quality. However, wilting was apparent in the treatments where Cellulose No. 2, plain water, and the water-retaining gel were used. Interestingly, the wilting was most pronounced where plain water was used. As shown in FIG. 1, there were differences in the degree of wilting of flowers between the treatments using Cellulose No. 1 and Cellulose No. 2, each aggregate using cellulose fiber as the principal component. This is despite the fact that the same nutrients were added at the same level to each treatment.

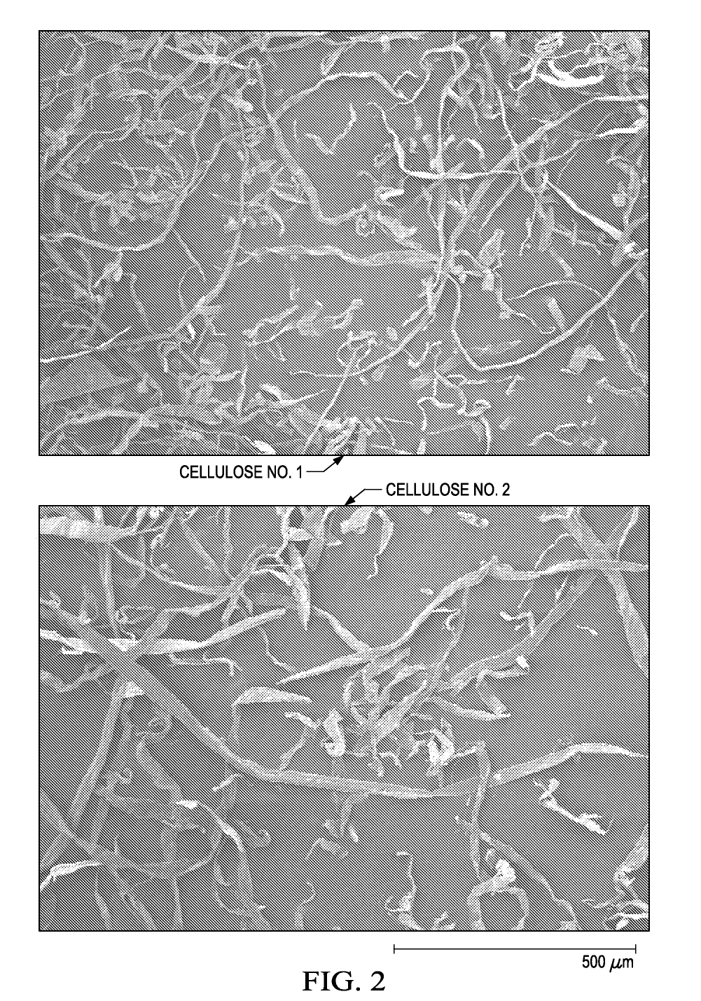

To determine the cause of this difference, scanned electron microscope (SEM) photographs were taken of the fiber aggregate. SEM photographs of the cellulose fibers are depicted in FIG. 2. When comparing Cellulose No. 1 (the upper depiction of FIG. 2), which maintained good flower quality, and Cellulose No. 2 (the lower depiction of FIG. 2), which exhibited wilting and poor flower quality, the differences in fiber diameter and length are evident.

According to the SEM analysis, the fibers in Cellulose No. 1, in which cut flowers had the least amount of wilting as seen in FIG. 1, had a smaller average diameter and generally shorter length than the fibers in Cellulose No. 2. In both cases, there was a high standard deviation in the fiber length. However, there was less variance in the diameter of fibers contained in each of the cellulose fiber aggregates. Therefore, it was concluded that fiber diameter is a more reliable predictor of the water retention ability of the fiber aggregate and the subsequent ability of the water retention agent to supply sufficient moisture to maintain flower freshness and quality.

To obtain accurate fiber diameter measurements, individual fibers were selected that did not exhibit twisting that was observed in the SEM photographs. The average fiber diameter of the aggregate that maintained the highest degree of flower freshness and the least amount of wilting was about 19.9 microns (with a standard deviation of about 2.2 microns). The average fiber diameter of the aggregate in which flower wilting was apparent was about 30.9 microns (with a standard deviation of about 5.6 microns).

It is believed that the smaller fiber diameter maintains better flower freshness and quality by allowing the aggregate to more thoroughly encase the stem and remain in closer contact with the cut stem surface. It is also believed that the aggregate with smaller fiber diameter can retain sufficient moisture to sustain flower freshness, and yet repeatably release this moisture to the flower stems to avoid stress and maintain a higher level of quality and freshness over time. Thus, satisfactory flower freshness may be maintained according to one or more aspects of the present disclosure by utilizing a cellulose fiber aggregate with an average fiber diameter of about 25 microns or less, as described above. Some implementations within the scope of the present disclosure may utilize a fiber aggregate with an average fiber diameter of about 20 microns or less. When a cellulose fiber aggregate with an average fiber diameter of about 20 microns or less is utilized, flower quality and freshness may be maintained for up to ten days, perhaps regardless of flower type.

To obtain the cellulose fiber within the scope of the present disclosure, one may utilize ordinary wood pulp as the source of fiber. The splitting, cutting, and/or other processes utilized to generate the wood pulp may be adjusted, depending on local parameters and/or machinery, to obtain the desired specification of fiber diameter. The wood pulp may also pose little or no environmental threat relative to previously utilized products, and may be safely disposed of in a landfill or by incineration after use.

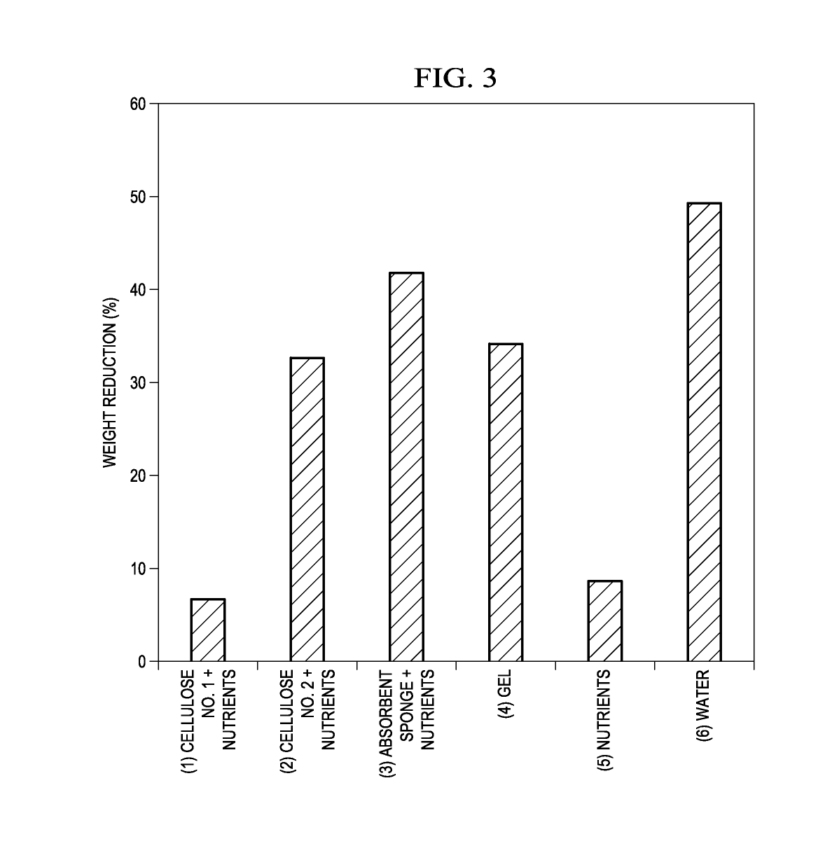

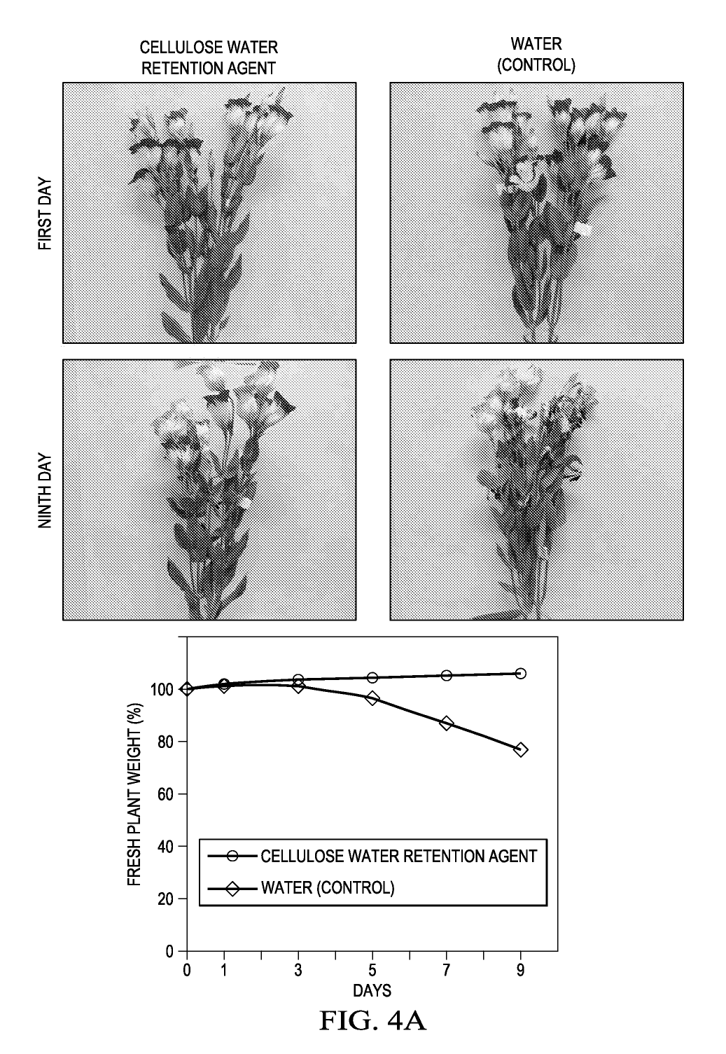

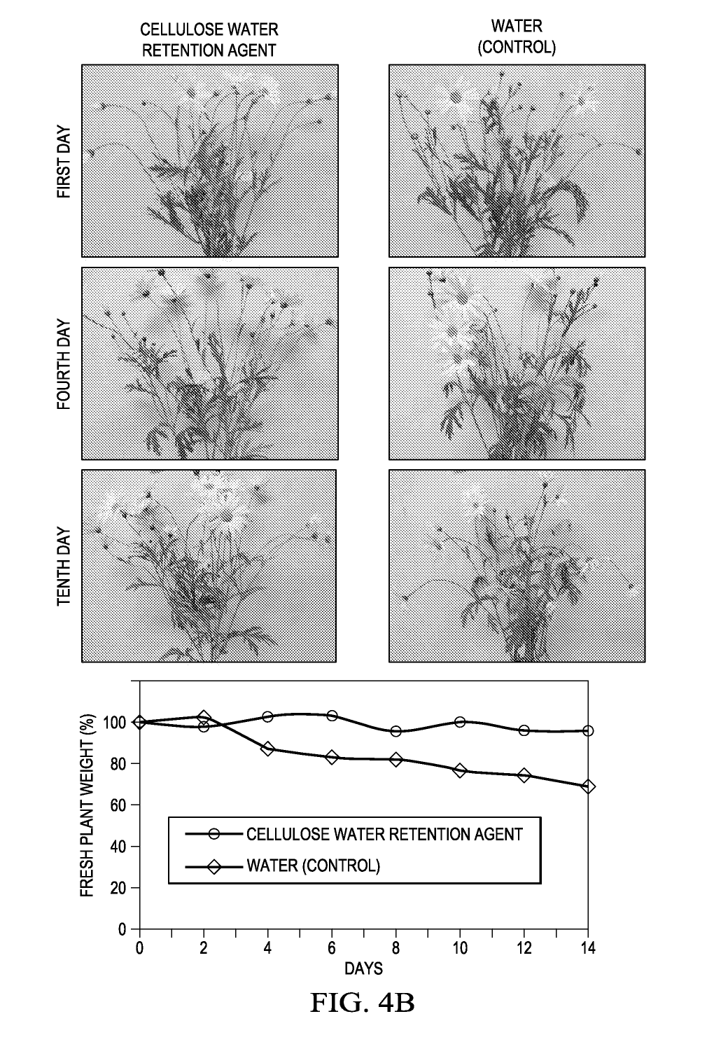

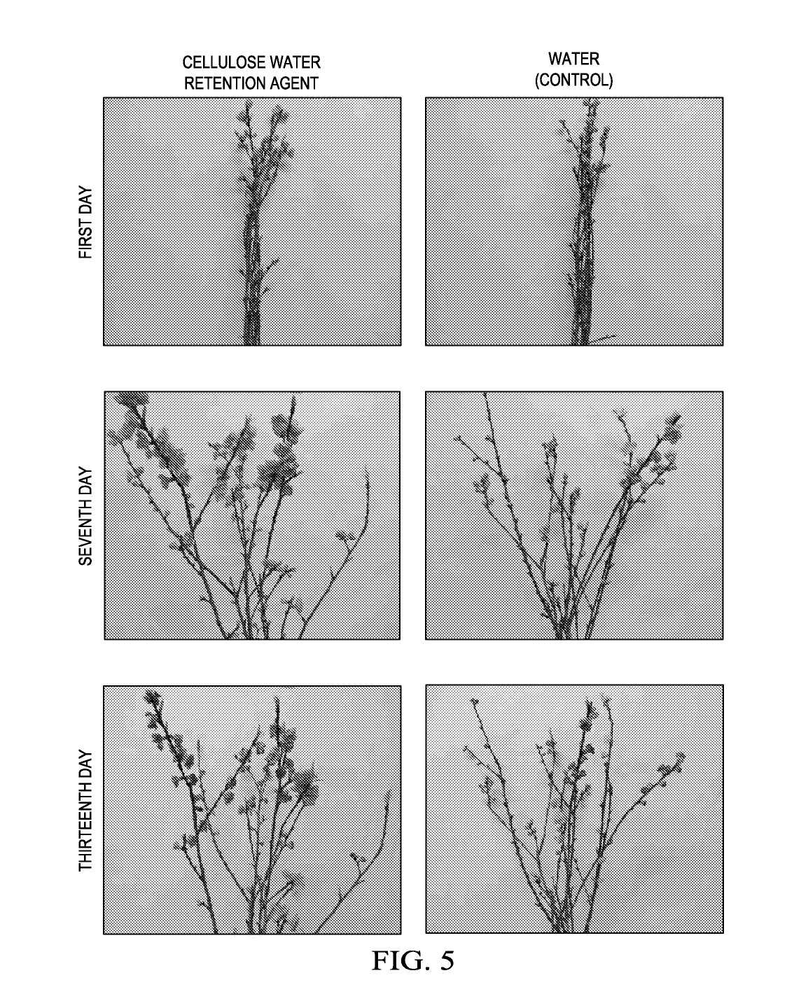

Example implementations demonstrating effectiveness of agents and/or methods introduced in the present disclosure will now be described. FIG. 3 depicts example effectiveness pertaining to rose plants, such as those depicted in FIG. 1. FIG. 4A depicts example effectiveness pertaining to Turkish Bellflower plants. FIG. 4B depicts example effectiveness pertaining to Margaret Aster plants. FIG. 5 depicts example effectiveness pertaining to Peach Blossom plants.

With respect to FIG. 3, rose sprays were drained, weighed, and inserted into various types of water retention agents in vinyl bags of the same size, and the openings were sealed. The plants were placed in a room and weighed at the initiation of the trial and at eight days after initiation. Using the weight of each rose spray on day 0 as 100%, each treatment was weighed on day 8 and the amount of fresh weight reduction was calculated. FIG. 3 depicts the reduction in weight after eight days for Treatment 1 (Cellulose No. 1, with impregnated nutrients); Treatment 2 (Cellulose No. 2, with impregnated nutrients); Treatment 3 (absorbent sponge, with impregnated nutrients); Treatment 4 (commercially available water-retaining gel); Treatment 5 (nutrients alone); and Treatment 6 (water alone).

Treatments 1-3 represent water-absorbent materials impregnated with nutrients. For Treatment 1, a fiber aggregate of the present disclosure with an average fiber diameter of about 20 microns with cellulose fiber as the principal component, the amount of reduction in weight after eight days was less than about 10%. In contrast, for Treatment 2, with the fiber aggregate having an average fiber diameter of about 30 microns, the reduction in weight after eight days was over 30%, and for Treatment 3, the absorbent sponge, the reduction in weight after eight days was over 40%. Each of Treatments 1-3 had identical levels of nutrients added to the impregnating solution. Visual observations of the treatments depicted in FIG. 3 also indicated that the fiber aggregate having an average fiber diameter of about 30 microns (Treatment 2) and the absorbent sponge (Treatment 3) exhibited obvious wilting of flower and leaves, and therefore may be considered as having limited commercial value to maintain freshness over time. However, the water retention agent containing a fiber aggregate with an average fiber diameter of about 20 microns as the water-absorbent material (Treatment 1) exhibited satisfactory quality, appearance, and freshness of both flowers and leaves.

The commercial water-retaining gel (Treatment 4), which is often used to transport, ship, and store fresh flowers, underwent a weight reduction of over 30% after eight days. The freshness and quality of cut flowers that were inserted directly into nutrients alone (Treatment 5) or water alone (Treatment 6) were also compared to flowers where the water retention agent of the present disclosure was utilized. When nutrients alone were utilized (Treatment 5), a reduction in weight of about 8.7% was recorded, and with water alone (Treatment 6), a 49.4% reduction, which are telling in comparison to the approximately 7% reduction obtained utilizing Treatment 1. This demonstrated the beneficial effect of nutrients on maintaining flower quality. However, when nutrients are used in conjunction with the cellulose fiber aggregate with a larger fiber diameter, or with an absorbent sponge, the presence of nutrients had little effect on flower quality or freshness, as evidenced by the higher reduction in weight resulting from Treatments 2 and 3. This demonstrates the ability to utilize a cellulose fiber aggregate containing fibers of the specified size of the present disclosure to maintain satisfactory cut flower appearance, quality, and freshness.

It is noted that the reduction in weight was 7% for the water retention agent of the present disclosure (Treatment 1) and 8.7% for nutrients alone (Treatment 5). Although the numerical difference between Treatments 1 and 5 was relatively small, the superiority of the water retention agent of the present disclosure in maintaining fresh flower quality was demonstrated. Furthermore, there is some difficulty in being able to use a nutrient mixture when shipping flowers, as it is subject to spillage such that the flowers must be packed in a vertical position. Therefore, it has been shown that that the freshness, quality, and appearance of fresh cut flowers can be maintained over time and in an easy-to-use manner by utilizing the water retention agent of the present disclosure.

Moreover, dry transport methods may sometimes be considered inferior to wet transport methods (where water is put into a container and flowers are inserted). However, the results depicts in FIG. 3 demonstrate that flowers inserted into plain water (Treatment 6) had a greater weight reduction after eight days than the other treatments.

By utilizing a water retention agent of the present disclosure with a cellulose fiber aggregate comprised of fibers with an average diameter of 25 microns or less, the beneficial effect on the quality and appearance of rose sprays is depicted in FIG. 3. Moreover, a water retention agent of the present disclosure may be utilized to a similar beneficial effect with cut flowers other than roses. For example, the water retention agent of the present disclosure was placed in bags in a manner to that described above. Water was also placed into a bag as a control. Sprays of Turkish Bellflower (Gentianaceae family) and Margaret Aster (Asteraceae family) were inserted into the bags, and the bags were closed around the flower stems to reduce evaporation. The weight and appearance of the flowers were recorded daily. FIG. 4A depicts the experimental results utilizing the Turkish Bellflower, and FIG. 4B depicts the experimental results utilizing the Margaret Aster. The initial weight of the flowers was set at 100%. The accompanying graphs in FIGS. 4A and 4B indicate the respective change in weight over time, and the depicted photographs illustrate the visual appearance of the flowers.

During the testing period for the Turkish Bellflower, the average temperature was about 25° C. with a relative humidity of about 59%. Where a water retention agent of the present disclosure was utilized with the Turkish Bellflower, the weight of the flowers gradually increased up to the ninth day, and the flowers maintained a satisfactory appearance (as shown in the bottom-left photo depicted in FIG. 4A). With plain water, however, the weight of the flowers decreased to less than about 80% by the ninth day, and exhibited wilting (as shown in the bottom-right photo depicted in FIG. 4A). Although not shown in the depicted photos, where the water retention agent of the present disclosure was utilized, the flowers maintained satisfactory quality and did not wilt until the thirteenth day.

During the testing period for the Margaret Aster, the average temperature was about 18° C. with a relative humidity of about 46%. Where the water retention agent of the present disclosure was utilized with the Margaret Aster, the weight remained fairly constant until the fourteenth day, and the flowers maintained a satisfactory appearance (resembling that shown in the bottom-left photo depicted in FIG. 4B). However, the flowers in plain water retained only about 70% of their original weight, showed signs of wilting by the fourth day (as shown in the middle-right photo depicted in FIG. 4B), and were severely wilted by the tenth day (as shown in the bottom-right photo depicted in FIG. 4B).

The effect of utilizing the water retention agent of the present disclosure to extend not only the vase life and quality of flowers, but also of woody plants, was evaluated, as depicted in FIG. 5. Peach Blossom stems were placed in a bag with the water retention agent of the present disclosure. The opening of each bag was closed around the stems to prevent evaporation, and the test subjects were stored in a room with an average temperature of about 15° C. and a relative humidity of about 48% during the test period. Plain water was used as the control treatment, and the stems were inserted into a bag and sealed in a similar manner and stored under the same conditions. As depicted in FIG. 5, the branches were photographed on the first, seventh, and thirteenth days of the study. At the start of the study, the branches in both treatments were primarily in the bud stage. Where the water retention agent of the present disclosure was utilized, the branches were at about 40% bloom by the fourth day, and at about 80% bloom by the thirteenth day. However, in the control treatment (plain water), the branches were at about 10% bloom by the fourth day, and at about 20% bloom by the thirteenth day. Furthermore, when utilizing the water retention agent of the present disclosure, numerous leaves emerged during the observation period. However, where plain water was used as the control treatment, only three leaves emerged during the observation period.

Thus, the water retention agent of the present disclosure may be utilized to prevent wilting and beneficially affect the appearance and quality of woody plants, such as peach blossom stems. Accordingly, as described herein, the water retention agent of the present disclosure may be suitable for use on both fresh cut flowers and woody plants to maintain freshness and appearance over time.

If the flower and ornamental plant water retention agent of the present disclosure, including a fiber aggregate with cellulose fiber as the principal component, is used for wet transport, better flower quality may be maintained than was possible in the past, as evidenced by the studies described herein. The cut flower and ornamental water retention agent of the present disclosure may positively affect the freshness, appearance, and quality of most types of cut flowers and woody plants over time. Furthermore, although the flower and ornamental water retention agent of the present disclosure is a wet type, its moisture holding and saturation capacity is high, which may reduce or avoid problems with spillage or leakage during transportation.

Additionally, with a method according to one or more aspects of the present disclosure, flowers and floral arrangements may be easily displayed in floral shops, supermarkets, and other point-of-sale locations because the bag covers only the stem ends, thus allowing the flowers to be seen and displayed. Traditional retail floral displays entail placing fresh flowers or ornamental plants in a bucket, vase, or other container with water. Microbes can propagate in such containers, which can cause flowers and ornamental plants to wilt or otherwise lose their visual appeal. Moreover, maintaining proper container hygiene entails frequently changing the water and washing/rinsing the containers. Accordingly, utilizing a method according to one or more aspects of the present disclosure may not only maintain freshness and appearance, but may also reduce the amount of labor associated with cleaning plant containers and replenishing water.

Thus, the present disclosure introduces a water retention agent in which 10-21 mL of an impregnating solution that has water as the principal component is added, per gram of fiber aggregate, to the fiber aggregate that has cellulose fiber with an average fiber diameter of about 25 microns or less as the principal component, such that the freshness, appearance, and quality of cut flowers may be maintained by inserting the stems into the fiber aggregate. Such approach may provide a water retention agent and water retention method for flowers and ornamental plants that may maintain freshness, appearance, and quality of cut flowers and ornamental plants over an extended period of time, perhaps with little or no leakage or spillage, and perhaps with ease of use for the producer, shipper, merchant, and consumer.

In view of the entirety of the present disclosure, including the figures, a person having ordinary skill in the art will readily recognize that the present disclosure introduces a fiber aggregate comprising: cellulose fibers as a principal component, wherein the cellulose fibers: have an average fiber diameter of about 25 microns or less; are clustered together; and per gram of fiber aggregate, hold about 10-21 mL of an impregnating solution that has water as a principal component. The fiber aggregate may be included as part of a water retention agent for at least one of flowers and ornamental (e.g., woody) plants. The fiber aggregate may further comprise wood pulp as a starting base material.

A person having ordinary skill in the art will also readily recognize that the present disclosure introduces a water retention method for flowers and ornamental plants, wherein the method comprises: inserting cut stem ends of at least one of flowers and ornamental plants into a water retention agent so as to be encased and covered by the water retention agent, wherein the water retention agent comprises cellulose fibers as a principal component, and wherein the cellulose fibers: have an average fiber diameter of about 25 microns or less; are clustered together; and per gram of fiber aggregate, hold about 10-21 mL of an impregnating solution that has water as a principal component. Such method may further comprise: inserting the water retention agent into a container before inserting the cut stem ends into the water retention agent; and closing the container after inserting the cut stem ends into the water retention agent. The container may be a leak-resistant container, and closing the container may comprise sealing the container closed. The container may be a plastic bag. The method may further comprise cutting the flowers and/or ornamental plants to create the cut stem ends before inserting the cut stem ends into the water retention agent. The method may further comprise: cutting the at least one of flowers and ornamental plants to create the cut stem ends before inserting the cut stem ends into the water retention agent; inserting the water retention agent into a container before inserting the cut stem ends into the water retention agent; and closing the container after inserting the cut stem ends into the water retention agent, wherein: the container is a leak-resistant container; closing the container comprises sealing the container closed; and the container is a plastic bag.

A person having ordinary skill in the art will also readily recognize that the present disclosure introduces an apparatus comprising: a plant having a cut end; a container substantially surrounding the cut end of the plant; and a water retention agent disposed in the container and substantially encasing the cut end of the plant, wherein the water retention agent comprises a fiber aggregate comprising cellulose fibers as a principal component, and wherein the cellulose fibers have an average fiber diameter of about 25 microns or less. Per gram of fiber aggregate, the cellulose fibers may hold about 10-21 mL of an impregnating solution that has water as a principal component. The plant may be a flower and/or a woody ornamental plant. The fiber aggregate may comprise wood pulp as a starting base material. The container may be a leak-resistant container within which the water retention agent is sealed. The container may be a plastic bag.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same purposes and/or achieving the same advantages of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

What is claimed is:

1. A fiber aggregate, comprising:
cellulose fibers as a principal component, wherein the cellulose fibers:
have an average fiber diameter of about 25 microns or less;
are clustered together; and
per gram of fiber aggregate, hold about 10-21 mL of an impregnating solution that has water as a principal component.

2. The fiber aggregate of claim 1 wherein the fiber aggregate is included as part of a water retention agent for at least one of flowers and ornamental plants.

3. The fiber aggregate of claim 1 further comprising wood pulp as a starting base material.

4. The fiber aggregate of claim 1 further comprising wood pulp as a starting base material, and wherein the fiber aggregate is included as part of a water retention agent for at least one of flowers and ornamental plants.

5. A water retention method for flowers and ornamental plants, comprising:
inserting cut stem ends of at least one of flowers and ornamental plants into a water retention agent so as to be encased and covered by the water retention agent, wherein the water retention agent comprises cellulose fibers as a principal component, and wherein the cellulose fibers:
have an average fiber diameter of about 25 microns or less;
are clustered together; and
per gram of fiber aggregate, hold about 10-21 mL of an impregnating solution that has water as a principal component.

6. The method of claim 5 further comprising:
inserting the water retention agent into a container before inserting the cut stem ends into the water retention agent; and
closing the container after inserting the cut stem ends into the water retention agent.

7. The method of claim 6 wherein the container is a leak-resistant container, and wherein closing the container comprises sealing the container closed.

8. The method of claim 7 wherein the container is a plastic bag.

9. The method of claim 5 further comprising cutting the at least one of flowers and ornamental plants to create the cut stem ends before inserting the cut stem ends into the water retention agent.

10. The method of claim 5 further comprising:
cutting the at least one of flowers and ornamental plants to create the cut stem ends before inserting the cut stem ends into the water retention agent;
inserting the water retention agent into a container before inserting the cut stem ends into the water retention agent; and
closing the container after inserting the cut stem ends into the water retention agent, wherein:
the container is a leak-resistant container;
closing the container comprises sealing the container closed; and
the container is a plastic bag.

11. An apparatus, comprising:
a plant having a cut end;
a container substantially surrounding the cut end of the plant; and
a water retention agent disposed in the container and substantially encasing the cut end of the plant, wherein the water retention agent comprises a fiber aggregate comprising cellulose fibers as a principal component, and wherein the cellulose fibers have an average fiber diameter of about 25 microns or less.

12. The apparatus of claim 11 wherein, per gram of fiber aggregate, the cellulose fibers hold about 10-21 mL of an impregnating solution that has water as a principal component.

13. The apparatus of claim 11 wherein the plant is a flower.

14. The apparatus of claim 11 wherein the plant is a woody ornamental plant.

15. The apparatus of claim 11 wherein the fiber aggregate comprises wood pulp as a starting base material.

16. The apparatus of claim 11 wherein the container is a leak-resistant container within which the water retention agent is sealed.

17. The apparatus of claim 16 wherein the container is a plastic bag.

18. The apparatus of claim 11 wherein:
per gram of fiber aggregate, the cellulose fibers hold about 10-21 mL of an impregnating solution that has water as a principal component;
the plant comprises at least one of a flower and a woody ornamental plant;
the fiber aggregate comprises wood pulp as a starting base material; and
the container is a leak-resistant plastic bag within which the water retention agent is sealed.
